(19) United States
(12) Patent Application Publication
(10) Pub. No.: US 2003/0067734 A1
(43) Pub. Date: Apr. 10, 2003

(54) Methods for electrostatically chucking an object to an electrostatic chuck that reduce uncorrectable placement error of the object

(75) Inventor: Katsushi Nakano, Kumagaya-shi (JP)

Correspondence Address: KLARQUIST SPARKMAN, LLP, One World Trade Center, Suite 1600, 121 S.W. Salmon Street, Portland, OR, 97204-2988, US

(73) Assignee: Nikon Corporation

(21) Appl. No.: 10/264,523

(22) Filed: Oct. 4, 2002

(30) Foreign Application Priority Data
Oct. 4, 2001 (JP) 2001-308192

(51) Int. Cl. H02H 1/00

(52) U.S. Cl. 361/234

(57) ABSTRACT

Methods are disclosed for electrostatically chucking an object (e.g., reticle or lithographic substrate used in charged-particle-beam microlithography) to an electrostatic chuck, in a manner resulting in reduction of uncorrectable placement errors that otherwise arise at time of chucking. The electrostatic chuck has multiple electrodes. After energizing the electrodes with respective voltages to cause the object to adhere electrostatically with a chucking force to the mounting surface, a voltage applied to at least one selected electrode is changed momentarily so as to reduce the chucking force momentarily in a corresponding region of the reticle sufficiently to reduce chucking stress in the object. Stress reduction typically is achieved by allowing the object to experience side-slip relative to the chuck. After a prescribed time period of stress reduction, the electrodes are energized sufficiently to hold the object to the chuck with a full chucking force. This sequence can be repeated multiple times as required to achieve a desired reduction of chucking stress in the object.

### FIELD

This disclosure pertains to microlithography performed using a charged particle beam. Microlithography, by which a pattern is transferred from a reticle to a substrate, is a key technology used in the fabrication of microelectronic devices such as semiconductor integrated circuits, displays, and the like. More specifically, this disclosure pertains to methods and devices for electrostatically holding a reticle or substrate to a respective stage in a charged-particle-beam (CPB) microlithography apparatus.

### BACKGROUND

In recent years, as the resolution limitations of optical microlithography have become increasingly apparent, much effort and expense has been devoted to the development of a practical “next generation lithography” (“NGL”) technology offering prospects of substantially finer pattern-transfer resolution than obtainable using optical microlithography. One promising NGL technology is so-called charged-particle-beam (CPB) microlithography.

In a conventional CPB microlithography apparatus, a pattern (e.g., circuit pattern) to be transferred to a substrate is defined on a reticle (sometimes called a “mask,” but termed “reticle” herein). The pattern on the reticle is illuminated by a charged-particle illumination beam, which forms a “patterned beam” as the illumination beam passes through the illuminated portion of the reticle. The patterned beam, carrying an aerial image of the illuminated portion of the pattern on the reticle, is directed to a desired location on the substrate by a projection lens portion of a CPB optical system.

Since it currently is impossible to transfer an entire reticle pattern to a substrate in a single exposure “shot” of the charged particle beam, the pattern as defined on the reticle is divided into small regions termed subfields each defining a respective portion of the pattern. The subfields are transferred to the substrate in individual respective shots. The respective images formed on the substrate are situated such that the images are “stitched” together to form the contiguous pattern on the substrate.

An exemplary CPB microlithography apparatus uses an electron beam as a representative charged particle beam. A typical reticle used in an electron-beam microlithography apparatus generally is formed by forming a pattern on the surface of a “reticle substrate” (e.g., silicon wafer) using micro-machining technology. By way of example, consider a “chip,” to be formed on a substrate, having dimensions of 20×25 mm on the substrate. Consider further that a total of 8,000 subfields is required for defining the entire pattern. These subfields can be arranged as a matrix of 80×100 subfields on the reticle. If each subfield image as formed on the substrate has dimensions of 250-μm square, and if microlithographic exposure is performed at a “reduction” (demagnification) ratio of ¼, then each subfield as defined on the reticle has dimensions of 1-mm square. Thus, a 80×100 subfield array on the reticle would have dimensions at least of 80×100 mm. However, in actuality, the reticle must be even larger to accommodate the reinforcing columns, called “struts,” that must be provided on the reticle between respective adjacent subfields to strengthen and rigidify the reticle. Hence, it readily is appreciated that a reticle substrate having a diameter of approximately 200 mm would be required to form the reticle.

Shown in FIG. 3(a) is an exemplary reticle 5 in which the reticle pattern is divided in two “pattern portions” 6A, 6B separated from each other by a wide central strut 7.

Since the charged particles in a charged particle beam collide with gas molecules in a gaseous atmosphere, the “optical” components of a CPB microlithography apparatus typically are enclosed in a vacuum chamber. Also enclosed in the vacuum chamber are the reticle and lithographic substrate. The reticle and substrate are mounted on respective stages that provide controlled positioning and movements of the reticle and substrate relative to each other during exposure, as well as accurate positional monitoring of the reticle and substrate. The reticle and substrate are mounted to their respective stages using a respective “chuck.” Because chucking of the reticle and substrate must be effected in a vacuum environment, the respective chucks are electrostatic types, by which is meant that the reticle and substrate are held on their respective chucks by electrostatic attraction. “Vacuum” chucks that hold the reticle and substrate, respectively, by vacuum suction, commonly are used in optical microlithography, which does not require a vacuum environment for the reticle and substrate.

An electrostatic chuck comprises multiple electrodes that are coated with an insulator to form a “mounting surface.” A high voltage (e.g., approximately 1.5 kV) is applied between the object to be chucked (reticle or substrate) and the electrodes, which generates an electrostatic force between the object and the electrodes. The electrostatic attraction holds the object firmly to the mounting surface.

An exemplary electrostatic chuck 1 is shown in FIGS. 3(a)-3(b). The depicted chuck is a reticle chuck 1 of which the mounting surface faces upward in the figure. The chuck 1 defines two openings 4 corresponding to the pattern portions 6A, 6B, respectively, of the reticle 5. The chuck 1 comprises multiple electrodes 2 located in the area surrounding the openings 4. The openings 4 are provided so as to allow the patterned beam (produced by passage of portions of an illumination beam, incident on the reticle 5 from upstream, through the illuminated portion of the reticle) to propagate unobstructed downstream of the reticle 5. Thus, it is not possible to situate the chuck electrodes 2 in regions corresponding to the pattern portions 6A, 6B. In this example, eight electrodes 2 are provided, having exemplary polarities (when energized) as shown in FIG. 3(b). The region 3 corresponds to the central strut 7 on the reticle 5.

Each electrode 2 has a respective polarity. In some chucks, all the electrodes have the same polarity. But, in the latter instance, energization of the electrodes produces an electrostatic force around the reticle 5. The field causes the reticle to be polarized, with the reticle surface facing the electrodes acquiring a net charge opposite in polarity to the electrode charge, and the reticle surface facing away from the electrodes acquiring a net charge having the same polarity as the electrode charge. Because the reticle 5 is thin, there is almost no difference in the electrostatic force operating on the front and rear surfaces of the reticle and electrodes, which prevents generation of a sufficiently large attraction force between the reticle 5 and chuck 1. One way in which to solve this problem is to bring a grounding electrode into contact with the reticle 5 to conduct away electric charges, having the same polarity as the electrodes, that have accumulated on the reticle opposite the electrodes (FIG. 3(c)). Unfortunately, because the contact resistance between the reticle 5 and the grounding electrode 8 tends to be large, an excessively long time is required for the charge to escape, which results in an undesirable increase in the response time of the chuck.

In view of the above, other conventional electrostatic chucks have multiple electrodes that are energized so as to present both polarities on the mounting surface, e.g., as shown in FIG. 3(b). I.e., some of the electrodes 2 are energized with positive voltage and other of the electrodes 2 are energized with negative voltage. With such a configuration, polarization occurs in the lateral direction inside the reticle, and charges having polarities that are opposite the polarity of the respective electrodes are concentrated in reticle regions adjacent the electrodes. This results in a large electrostatic attraction force operating between the electrodes and the reticle.

In actual reticle chuck configured as shown in FIG. 3(b), for example, the respective sizes of the electrodes are not perfectly identical. These size differences can cause corresponding differences in electrostatic capacity between the respective electrodes and the reticle due to disparities in insulator-film thickness, in warping and thickness of the reticle, and in dielectric constant. This situation is shown in FIG. 3(c), in which the left-hand capacitor has a smaller electrostatic capacity than the right-hand capacitor. As a result, it is necessary for a certain fixed amount of electric charge to be drawn out from the reticle to ground. For such a purpose, a needle-shaped grounding electrode 8 is brought into contact with the surface of the reticle 5. However, in this case as well, the rate at which electric charge can flow in and out of the reticle via the grounding electrode 8 is low, which prevents obtaining a desired rapid response rate of the chuck.

Whenever a reticle or substrate is chucked using this type of electrostatic chuck, positional dislocations (placement errors) of the reticle or substrate, respectively, arise due to stress produced by chucking. This placement error occurs mainly from two causes, discussed below in the context of chucking a reticle, for example.

The first cause is manifest whenever a reticle 5 having even a slight warp is attached electrostatically to an electrostatic chuck 1 of which the mounting surface is precisely planar. As the reticle 5 is being attracted to the mounting surface, the reticle undergoes some flexure to conform to the planar mounting surface. As a result, at least some of the reticle warp is corrected, but is accompanied by a corresponding positional dislocation of the reticle on the chuck. This positional dislocation conventionally is thought to be reproducible and thus cancelable.

The second cause is manifest whenever even a slight force, having a direction extending parallel to the plane of the reticle 5 on the mounting surface, occurs at the mounting surface as the reticle (which is a flexible body) is chucked forcibly to the rigid mounting surface. The force, which has poor reproducibility, causes warping of the reticle 5 and generally is not cancelable.

Modem CPB microlithography apparatus are expected to perform transfer of patterns having minimum linewidths of 100 nm or less on the substrate, while nevertheless achieving excellent stitching accuracy. Hence, it is necessary to limit the contribution, to overall stitching tolerance, of reticle-placement error to approximately 5 nm or less (i.e., approximately 20 nm on the reticle if the demagnification ratio is ¼).

The foregoing does not mean that reticle-placement errors occur only from stress arising from electrostatic chucking. Other causes include reticle-manufacturing errors and thermal expansion of the reticle 5. Hence, it is desirable that reticle-placement errors caused by stress generated by electrostatic chucking of the reticle be even smaller.

Reticle-manufacturing errors can be measured using reticle-measuring equipment before the reticle 5 is used for exposure. It is possible to perform measurement of reticle-manufacturing errors for all of the subfields (e.g., 8,000 subfields) and to correct the respective errors during exposure of each subfield. Any reproducible reticle-placement errors also can be corrected readily. However, reticle stress arising from chucking the reticle has poor reproducibility and cannot be estimated in advance. Consequently, these non-reproducible reticle-placement errors are uncorrected and directly cause significant degradation of subfield-stitching accuracy.

### SUMMARY

In view of the shortcomings of conventional devices and methods as summarized above, the present invention provides, inter alia, electrostatic chucks and electrostatic chucking methods for reticles or substrates as used in a charged-particle-beam (CPB) microlithography apparatus. Compared to conventional electrostatic chucks, the subject chucks achieve further reductions in uncorrectable placement errors arising due to stress imparted to the reticle or substrate by chucking.

According to a first aspect of the invention, methods are provided for chucking an object to an electrostatic chuck including multiple electrodes and a mounting surface. An embodiment of such a method comprises the step of energizing the electrodes with respective voltages to cause the object to adhere with an electrostatic chucking force to the mounting surface. A voltage applied to at least one selected electrode is changed so as to reduce the chucking force momentarily in a corresponding region of the reticle sufficiently to relieve and thus reduce chucking stress in the object. After reducing the chucking stress, the electrodes are energized to resume holding the object to the mounting surface with the chucking force.

In this method, the chucking stress (stress that arises in the object at time of chucking) is reduced substantially by allowing the stress to be relieved. Stress relief is facilitated by the momentary application of reduced chucking force to the object. This reduced chucking force desirably is sufficient to allow the object to side-slip, relative to the mounting surface, as required to relieve chucking stress in the object without allowing the object to become fully released from the mounting surface.

If stress is concentrated in a certain region of the object, chucking the object at a full chucking force without allowing relief of the stress results in the stress continuing to urge elastic deformation of the object. But, allowing side-slip of the object in the manner summarized above alleviates the stress and consequently the elastic deformation, even after restoration of chucking force to the object. As a result, any residual placement error caused by chucking the object is the reproducible type (i.e., placement error caused by stress imparted by correction of warp of the object). Because such placement error is reproducible, it can be corrected in a predictable manner.

The “object” referred to above typically is a reticle or lithographic substrate, in which instance the electrostatic chuck usually is situated on a reticle stage or substrate stage, respectively.

As noted above, the step of momentarily changing the voltage is performed within a time period sufficient to reduce the chucking stress applied to the object without allowing the object to become fully released from the mounting surface. In the step of momentarily changing the voltage, the voltage applied to the at least one selected electrode desirably is less than the voltage applied to the at least one selected electrode to produce the chucking force. For example, the voltage applied to the at least one selected electrode can be zero volts. Alternatively, the voltage can have an opposite polarity from the voltage applied to the at least one selected electrode to produce the chucking force.

The step of momentarily changing the voltage can be performed multiple times at a selected period. The period desirably is substantially equal to a mechanical resonance frequency of the object. The method of claim 1, wherein the step of momentarily changing a voltage can be performed in a sequential manner on respective selected one or more electrodes.

During the step of momentarily changing the voltage, the selected one or more electrodes can be changed in a sequential manner at a selected period. The period can be substantially equal to a mechanical resonance frequency of the object. Under such a condition, the object can be urged to move with relatively high-amplitude motions in response to relatively low-amplitude modulations of chucking force, thereby increasing the operational efficiency of stress relief of the object. Note that “substantially equal” need not be absolutely equal, but can be sufficiently close to exhibit a desired level of operational efficiency. By way of example, substantially equal can be a period sufficiently close to the resonance frequency to motion of the object within a range of −3 dB to −6 dB of the maximum amplitude.

Another embodiment of a method for chucking an object to an electrostatic chuck utilizes a chuck of which the electrodes are arranged around a circumference of the mounting surface. In a first step, one or more of the electrodes (but not all the electrodes) are energized sufficiently to hold the object electrostatically to the mounting surface. While energizing at least one electrode so as to be at a reduced-voltage status relative to the other energized electrodes, the reduced-voltage status is shifted sequentially to an adjacent electrode. This shift is continued progressively at least once around the circumference sufficiently to disperse and thus reduce chucking stress in the object. After reducing the stress, all the electrodes can be energized so as to hold the object to the mounting surface with a full chucking force.

By initially holding the object to the mounting surface with some of the electrodes not energized, stress in the object becomes concentrated in regions adjacent the non-energized electrode(s). By sequentially shifting the reduced-voltage status from one electrode to another at least once (desirably multiple times) around the circumference of the mounting surface, the concentrations of stress in the object similarly are urged to shift circumferentially, which gradually disperses the stress in the object in a circumferential manner. After a sufficient number of lateral shifts, the distribution of residual stress reaches an equilibrium status. At the equilibrium, the residual stress is unaffected by application of full chucking force. As a result, any residual placement error caused by chucking the object is the reproducible type (i.e., placement error caused by stress imparted by correction of warp of the object). Because such placement error is reproducible, it can be corrected in a predictable manner.

In this embodiment, the reduced-voltage status can be an OFF status for the respective electrode. Alternatively, the reduced-voltage status can be an opposite-polarity status, compared to a normal voltage polarity, for the respective electrode. In any event, the chucking force applied to the object by the electrode is made momentarily less than the normal chucking force, which allows the object to side-slip, as summarized above. The momentary opposite-polarity status can result in the side-slip condition being achieved more rapidly.

The sequential shifting step can be performed at a period substantially equal to a mechanical resonance frequency of the object. Under such a condition, the object can be urged to move with relatively high amplitude motions in response to relatively low-amplitude modulations of chucking force, thereby increasing the operational efficiency of stress relief of the object. Note that “substantially equal” need not be absolutely equal, but can be sufficiently close to exhibit a desired level of operational efficiency. By way of example, substantially equal can be a period sufficiently close to the resonance frequency to motion of the object within a range of −3 dB to −6 dB of the maximum amplitude.

The initial step of energizing the electrodes can comprise energizing first a selected at least one electrode, then a selected at least one adjacent electrode, and so on until only a selected at least one electrode remains OFF. The sequential shifting step desirably begins with the selected at least one electrode that is OFF. This can be followed by sequentially shifting the reduced-voltage status from one electrode to another at least once (desirably multiple times) around the circumference of the mounting surface, as described above. As energization of the electrodes is shifted sequentially in this manner, the stress in the object is concentrated at a location in the object adjacent the last electrode to be turned on. With at least one electrode being in a reduced-voltage status, the reduced-voltage status is shifted sequentially to an adjacent electrode. This shift is continued progressively at least once around the circumference sufficiently to disperse and thus reduce chucking stress in the object. After reducing the stress, all the electrodes can be energized so as to hold the object to the mounting surface with a full chucking force.

Another embodiment of a method for chucking an object to an electrostatic chuck utilizes a chuck of which the electrodes are arranged around a circumference of the mounting surface. In a first step the electrodes are energized with respective voltages to hold the object electrostatically to the mounting surface. A respective voltage applied to at least one selected electrode is reduced momentarily to provide the at least one selected electrode with a changed-voltage status relative to the other energized electrodes. The changed-voltage status is shifted sequentially to an adjacent electrode. This shift is continued progressively at least once around the circumference sufficiently to disperse and thus reduce chucking stress in the object. Then, all the electrodes are energized so as to hold the object to the mounting surface with a full chucking force.

Again, the reduced-voltage status can be an OFF status for the respective electrode or an opposite-polarity status, compared to a normal voltage polarity, for the respective electrode. Also, desirably, the sequential shifting step is performed at a period substantially equal to a mechanical resonance frequency of the object.

The foregoing and additional features and advantages of the invention will be more readily apparent from the following detailed description, which proceeds with reference to the accompanying drawings.

### BRIEF DESCRIPTION OF THE DRAWINGS

FIGS. 1(a)-1(d) are schematic elevational views showing respective steps in a method according to a first representative embodiment, each figure showing a reticle and two exemplary chuck electrodes.

FIGS. 2(a)-2(h) and 2(j) are schematic plan views showing a sequence of electrode energizations in a method according to a second representative embodiment.

FIG. 2(i) is an oblique view showing all but one electrode being energized, with reticle stress being concentrated at a region of the reticle corresponding to the non-energized electrode.

FIG. 3(a) is an oblique view of a conventional electrostatic chuck and segmented reticle as used in charged-particle-beam microlithography.

FIG. 3(b) is a plan view of the mounting surface of the chuck shown in FIG. 3(a).

FIG. 3(c) is a schematic elevational view of the chuck of FIG. 3(a), with reticle mounted thereto, showing energization of two electrodes with opposite polarity and contact of a grounding electrode to the reticle.

### DETAILED DESCRIPTION

The invention is described below in the context of representative embodiments that are not intended to be limiting in any way. Although the embodiments are especially suitable for use in electron-beam microlithography, it will be understood that the general principles described herein are applicable with equal facility to microlithography apparatus using another type of charged particle beam, as well as to any other type of microlithography apparatus utilizing an electrostatic chuck for holding the reticle or lithographic substrate, for example. Also, although the embodiments are described in the context of a reticle being the object held by a reticle chuck, it will be understood that the chuck alternatively can be a substrate chuck (“wafer chuck”) and the object a lithographic substrate, for example.

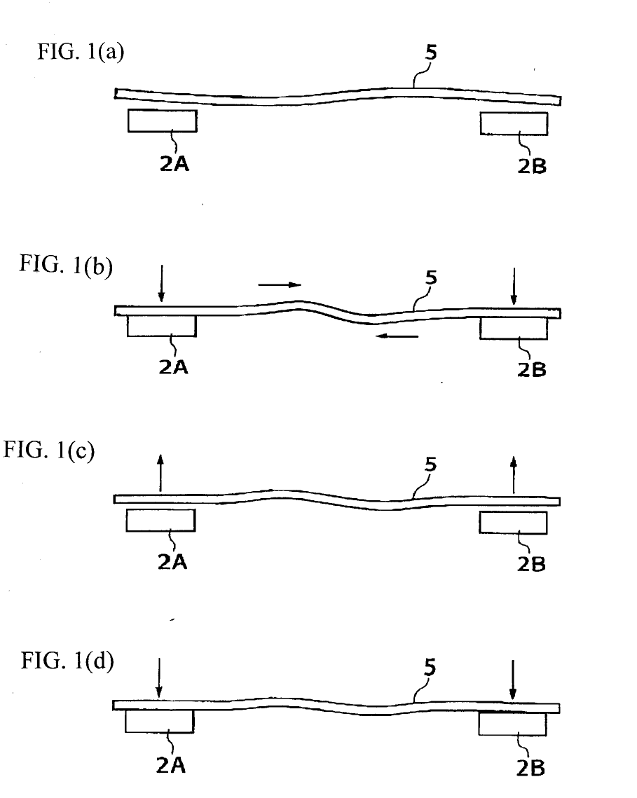

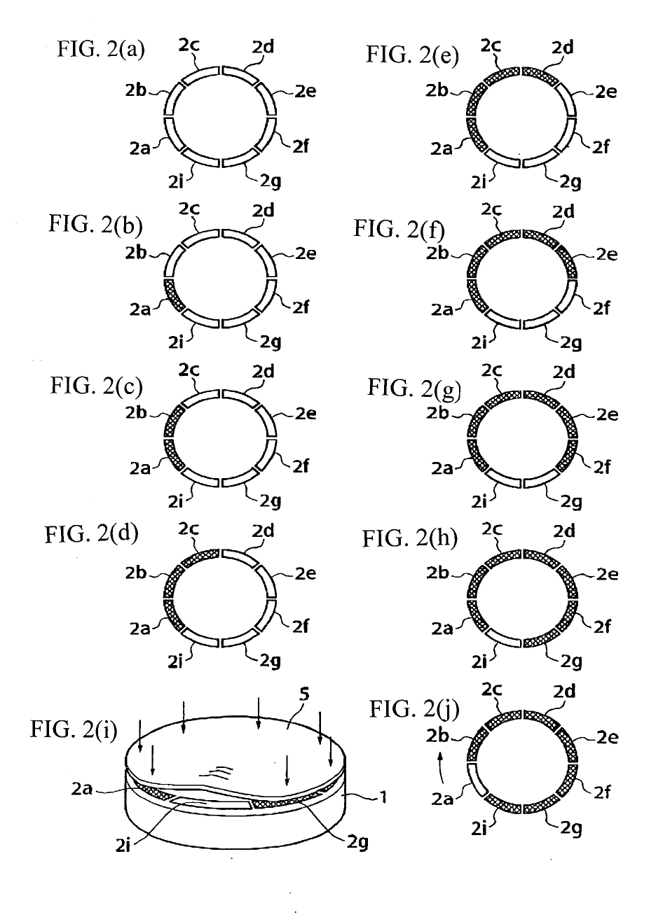

FIGS. 1(a)-1(d) depict certain aspects of the first representative embodiment. Specifically, these figures depict, in schematic fashion, a reticle 5 relative to two electrodes 2A, 2B of an electrostatic chuck. FIG. 2(a) depicts a warped reticle 5 before the reticle is mounted to the chuck. In FIG. 2(b), the reticle 5 is shown being attracted (vertical arrows) electrostatically to the two electrodes 2A, 2B, resulting in “chucking” of the reticle to the mounting surface of the chuck. Chucking is achieved by applying a suitable respective voltage to each of the electrodes 2A, 2B. As can be seen, the act of chucking the reticle 5 causes the reticle 5 to distort. The distortion imposes a stress (horizontal arrows) to the chuck surface. The stress, in turn, produces a placement error.

In FIG. 1(c), the chucking force is reduced momentarily by momentarily reducing the energization voltage applied to the electrodes 2A, 2B. Such force reduction can be achieved by momentarily reducing the applied voltage to zero volts. Thus, the attractive force applied by the chuck to the reticle 5 is reduced momentarily to a magnitude intermediate a zero force (reticle fully released from the chuck) and a force characteristic of a fully chucked reticle. The intermediate force is sufficient to keep the reticle attached to the chuck while allowing the reticle to “side-slip” relative to the mounting surface as required for relieving the stress in the reticle. A subsequent return to full energization in FIG. 2(d) yields the reticle 5 being mounted to the chuck with full chucking force but a residual stress that is much lower than shown in FIG. 2(b).

The momentary reduction of chucking force (FIG. 2(c)) is an unstable condition because, if allowed to continue too long, the reticle 5 undesirably would be released fully from the chuck. Full release essentially would cause the reticle and chuck to return to the status shown in FIG. 1(a), wherein subsequent energization of the electrodes 2A, 2B would return the status to that shown in FIG. 1(b). Hence, the time duration of the momentary reduction is less than an amount of time that would allow full release (e.g., less than an amount of time that would allow the reticle to fall from the reticle).

By repeating the sequence shown in FIGS. 1(b) and 1(c) multiple times, chucking stress in the reticle is reduced substantially. When the status shown in FIG. 1(d) is reached, chucking stress has been reduced to a magnitude substantially less than in conventional chucking methods. Also, in FIG. 1(d), the reticle 5 is more nearly planar than in the status shown in FIG. 2(b).

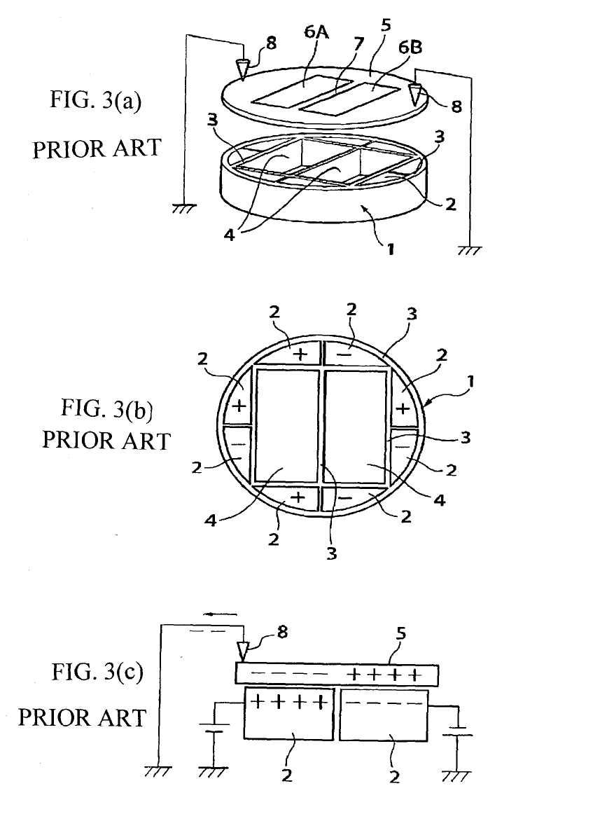

In the status shown in FIG. 1(c), the respective voltages applied to the electrodes 2A, 2B are reduced momentarily. This reduction can be achieved by simply reducing the voltage to a lower voltage or by reducing the voltage to zero. However, even a momentary reduction to zero volts does not reduce the chucking force instantaneously to zero. This is because, as shown in FIG. 3(c), electric charges actually flow into and out of the reticle 5 via a grounded electrode 8 that contacts the reticle with a high contact resistance. Consequently, a discrete length of time is required for the electric charge to flow into or out of the reticle 5.

Under certain circumstances it is desirable that the chucking force be turned off momentarily more instantaneously than achievable in the manner described above. One manner in which to achieve a more rapid reduction of chucking force is to reverse the polarity of the voltage applied to the electrodes 2A, 2B, rather than simply reducing the voltage. Because a certain length of time is required for electrical charges to move within the reticle in response to the reversal of electrode polarity, after an instantaneous change in electrode polarity, the reticle surface facing the electrodes momentarily has the same polarity as the electrodes. This juxtaposition of like charges produces a corresponding momentary repulsive force between the reticle and the electrodes.

By changing the electric potentials applied to the chuck electrodes in the manner described above, the force acting between the reticle and chuck can be changed momentarily from strongly attractive to less attractive or from strongly attractive to repulsive. By making appropriate adjustments in the respective magnitudes of these forces and the frequency with which the magnitudes and directions of the forces are changed, the reticle is maintained in a stress-alleviated status for time sufficient to allow the reticle to side-slip and thus reduce chucking stress in the reticle.

The extent to which the attractive force between reticle and chuck can be varied by modulating voltages applied to the chuck electrodes also depends upon the modulation frequency and the mechanical resonance frequency of the reticle. If the modulation frequency is matched to the resonance frequency of the reticle, then modulating the applied voltages places the reticle into a resonant condition. As a result, the reticle exhibits relatively high-amplitude movements relative to the mounting surface in response to relatively small modulations in applied voltage. Higher-amplitude movements of the reticle more easily achieve the desired side-slip (and hence stress reduction) with less risk of the reticle falling off the mounting surface of the chuck.

The modulation frequency also is a function of several other variables. One of these variables is a time constant that is a function of the electrostatic capacity of the chuck and the contact resistance of the grounding electrode 8 with the reticle 5. If modulation of electrode voltage is performed at a frequency approximately equal to the time constant, then the chucking force applied to the reticle is changed synchronously with the modulation frequency. If modulation of electrode voltage is performed at a frequency higher than the time constant, the chuck will be unable to respond in a synchronous manner. Thus, the chucking force can be weakened or even converted momentarily to a repulsive force between the reticle and the chuck. Appropriate adjustments in the frequency of electrode-voltage modulation and in the resulting amplitude of responsive changes of chucking force can be made that reflect distinctive compatibility aspects of certain reticles with certain chucks, including variations in contact resistance of grounding electrodes, etc.

A second representative embodiment is depicted in FIGS. 2(a)-2(j). The electrostatic chuck 1 in this embodiment is cylindrical (see FIG. 2(i)), with eight similarly sized arc-shaped electrodes 2a-2i arranged equi-angularly around the circumference of the mounting surface. In the figures, electrodes to which a voltage is being applied are shaded, and electrodes to which a voltage is not being applied are not shaded.

FIG. 2(a) shows the status of electrode energization prior to chucking, wherein no voltage is being applied to any of the electrodes 2a-2i. Starting from this status, a reticle is placed on the mounting surface, and a voltage is applied only to one electrode 2a (FIG. 2(b)). Then, a voltage also is applied to the clockwise adjacent electrode 2b (FIG. 2(c)). The polarity of voltage applied to the electrode 2b is opposite the polarity of voltage applied to the electrode 2a. Thereafter, as shown in FIGS. 2(c)-2(h), voltages with opposite polarities are applied sequentially to the electrodes 2a-2g in a clockwise manner in the figures.

Reticle warp caused by chucking stress when the electrodes 2a-2g are energized as shown in FIG. 2(h) is depicted in FIG. 2(i). Whenever sequential electrode energization is performed as described above, chucking stress tends to concentrate in the portion of the reticle not situated adjacent an energized electrode. Hence, in the next step, shown in FIG. 2(j), the non-energized status is shifted to the adjacent electrode in a clockwise manner. By repeating this shifting of the non-energized electrode around the chuck, the stress previously concentrated at one location in the reticle is dispersed gradually around the circumference of the reticle, thereby substantially alleviating the stress in the reticle. Desirably, this shifting of the non-energized electrode is continued at least one around the circumference of the reticle before energizing all the electrodes to achieve maximal chucking force.

In the sequence shown in FIGS. 2(a)-2(j), first one electrode was energized, then two, then three, and so on. Alternatively, it is possible to energize all of the electrodes 2a-2i simultaneously, then selectively de-energize one of the electrodes, and then sequentially shift the de-energized electrode circumferentially in a manner similar to the scheme described above. This alternative method is desired whenever the initial stress acts more uniformly on the reticle (such a distribution of stress is easier to alleviate).

In the sequence shown in FIGS. 2(a)-2(j), one electrode was de-energized selectively. Alternatively, the electrode situated radially opposite the de-energized electrode also can be de-energized, and sequential de-energization of respective radially opposing pairs of electrodes can be shifted circumferentially. In addition, the additional de-energized electrode need not be the electrode in radial opposition to the first de-energized electrode. In any event, in this scheme, the area of the reticle not actually being attracted to the chuck is larger than when only one electrode is de-energized, which facilitates reticle side-slip. Also, with this scheme, reticle-stress alleviation can be achieved in a shorter period of time than the scheme shown in FIGS. 2(a)-2(i).

Although this embodiment was described in the context of turning OFF the voltage supplied to the selected electrode(s), it alternatively is possible simply to reduce the voltage applied to the selected electrode(s), add a desired voltage of opposite polarity to the voltage applied to the selected electrode(s), or completely reverse the polarity of voltage applied to the selected electrode(s).

Also, the frequency with the selected electrode(s) is shifted circumferentially can be any desired frequency and may be adjustable. If the frequency is close to the mechanical-resonance frequency of the reticle, then relatively large displacements of the reticle relative to the chuck can be produced with relatively small changes in applied voltage to the selected electrode(s). Also, especially if the responsiveness of the chuck is not a problem, the voltages applied to the respective electrodes may have the same polarity.

Therefore, the invention achieves a reduction in the uncorrectable placement error that conventionally occurs due to reticle stress imposed at the time of reticle chucking. The reduced placement error yields an improved stitching accuracy of the exposed pattern.

Whereas the invention has been described above in the context of representative embodiments, the invention is not limited to those embodiments. On the contrary, the invention is intended to encompass all modifications, alternatives, and equivalents as may be included within the spirit and scope of the invention, as defined by the appended claims.

What is claimed:

1. A method for chucking an object to an electrostatic chuck including multiple electrodes and a mounting surface, the method comprising the steps:
energizing the electrodes with respective voltages to cause the object to adhere electrostatically with a chucking force to the mounting surface;
momentarily changing a voltage applied to at least one selected electrode so as to reduce the chucking force momentarily in a corresponding region of the reticle sufficiently to relieve and thus reduce chucking stress in the object; and
energizing the electrodes to resume holding the object to the mounting surface with the chucking force.

2. The method of claim 1, wherein:
the object is a reticle or lithographic substrate; and
the electrostatic chuck is situated on a reticle stage or substrate stage, respectively.

3. The method of claim 1, wherein the step of momentarily changing the voltage is performed within a time period sufficient to reduce the chucking stress without allowing the object to become fully released from the mounting surface.

4. The method of claim 1, wherein, in the step of momentarily changing the voltage, the object is allowed to side-slip relative to the mounting surface, to relieve chucking stress in the object without allowing the object to become fully released from the mounting surface.

5. The method of claim 1, wherein, in the step of momentarily changing the voltage, the voltage applied to the at least one selected electrode is less than the voltage applied to the at least one selected electrode to produce the chucking force.

6. The method of claim 1, wherein, in the step of momentarily changing the voltage, the voltage applied to the at least one selected electrode is zero.

7. The method of claim 1, wherein, in the step of momentarily changing the voltage, the voltage applied to the at least one selected electrode has an opposite polarity from the voltage applied to the at least one selected electrode to produce the chucking force.,

8. The method of claim 1, wherein the step of momentarily changing the voltage is performed multiple times at a selected period.

9. The method of claim 8, wherein the period is substantially equal to a mechanical resonance frequency of the object.

10. The method of claim 1, wherein the step of momentarily changing the voltage is performed in a sequential manner on respective selected one or more electrodes.

11. The method of claim 10, wherein, during the step of momentarily changing the voltage, the selected one or more electrodes is changed in a sequential manner at a selected period.

12. The method of claim 11, wherein the period is substantially equal to a mechanical resonance frequency of the object.

13. A method for chucking an object to an electrostatic chuck including multiple electrodes and a mounting surface, the electrodes being arranged around a circumference of the mounting surface, the method comprising the steps:
energizing one or more of the electrodes, but not all the electrodes, sufficiently to hold the object electrostatically to the mounting surface;
while energizing at least one electrode so as to be at a reduced-voltage status relative to the other energized electrodes, sequentially shifting the reduced-voltage status to an adjacent electrode, and continuing the shift progressively at least once around the circumference sufficiently to disperse and thus reduce chucking stress in the object; and
energizing all the electrodes so as to hold the object to the mounting surface with a full chucking force.

14. The method of claim 13, wherein:
the object is a reticle or lithographic substrate; and
the electrostatic chuck is a situated on a reticle stage or substrate stage, respectively.

15. The method of claim 13, wherein the reduced-voltage status is an OFF status for the respective electrode.

16. The method of claim 13, wherein the reduced-voltage status is an opposite-polarity status, compared to a normal voltage polarity, for the respective electrode.

17. The method of claim 13, wherein the sequential shifting step is performed at a period substantially equal to a mechanical resonance frequency of the object.

18. The method of claim 13, wherein the initial step of energizing the electrodes comprises energizing first a selected at least one electrode, then a selected at least one adjacent electrode, and so on until only a selected at least one electrode remains OFF.

19. The method of claim 18, wherein the sequential shifting step begins with the selected at least one electrode that is OFF.

20. A method for chucking an object to an electrostatic chuck including multiple electrodes and a mounting surface, the electrodes being arranged around a circumference of the mounting surface, the method comprising the steps:
energizing the electrodes with respective voltages to hold the object electrostatically to the mounting surface;
reducing a respective voltage applied to at least one selected electrode to provide the at least one selected electrode with a changed-voltage status relative to the other energized electrodes;
sequentially shifting the changed-voltage status to an adjacent electrode, and continuing the shift progressively at least once around the circumference sufficiently to disperse and thus reduce chucking stress in the object; and
energizing all the electrodes so as to hold the object to the mounting surface with a full chucking force.

21. The method of claim 20, wherein:
the object is a reticle or lithographic substrate; and
the electrostatic chuck is a situated on a reticle stage or substrate stage, respectively..

22. The method of claim 20, wherein the reduced-voltage status is an OFF status for the respective electrode.

23. The method of claim 20, wherein the reduced-voltage status is an opposite-polarity status, compared to a normal voltage polarity, for the respective electrode.

24. The method of claim 20, wherein the sequential shifting step is performed at a period substantially equal to a mechanical resonance frequency of the object.

25. The method of claim 20, wherein the initial step of energizing the electrodes comprises energizing first a selected at least one electrode, then a selected at least one adjacent electrode, and so on until only a selected at least one electrode remains OFF.

26. The method of claim 20, wherein the sequential shifting step begins with the selected at least one electrode that is OFF.
